(19) United States
(12) Patent Application Publication
(10) Pub. No.: US 2004/0064628 A1
(43) Pub. Date: Apr. 1, 2004

(54) IMPROVED BACKPLANE WITH AN ACCELERATED GRAPHIC PORT IN INDUSTRIAL COMPUTER

(76) Inventor: Tsai-Sheng Chiu, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,445

(22) Filed: Apr. 10, 2003

Related U.S. Application Data
(63) Continuation-in-part of application No. 10/065,236, filed on Sep. 27, 2002.

(51) Int. Cl. G06F 13/00

(52) U.S. Cl. 710/315; 710/300; 710/301

(57) ABSTRACT

An improved backplane with an accelerated graphic port (AGP) in industrial computer for electrically connecting a CPU interface card therein. The backplane has at least a first type bus expansion slot, a second type bus expansion slot, a bus bridge device, and an AGP slot mounted thereon. The bus bridge device is designed as converting different-type bus signals between the first type bus expansion slot and the second type bus expansion slot when the first type bus expansion slot receives the CPU interface card therein. By way of the design of mounting the AGP slot and the bus bridge device on the backplane, the volume of CPU interface card can be reduced and therefore does not occupy the demanded space of other adjacent interface cards, and converts a variety of signals from the backplane.

### CROSS REFERENCE TO RELATED APPLICATIONS

This application is a continuation-in-part of applicant's earlier application, Ser. No. 10/065,236, filed Sep. 27, 2002.

### BACKGROUND OF INVENTION

1. Field of the Invention

The present invention is related to an improvement of backplane having an accelerated graphic port (AGP), and more specifically to a backplane connecting an external CPU interface for converting different bus signals between a CPU interface card and a backplane.

2. Description of the Prior Art

Industrial computers applied in the manufacturing industry are developed quickly in modern information technology society. In order to increase manufacturing capacity, the development of peripheral instruments applied in an industrial computer, such as central processing units (CPUs), interface cards, and display cards focuses on rapid computing and quick display.

In the industrial computer application field, each industrial computer or server might communicate with other computers or perform remote control on manufacturing processing by terminals. Both the communication and remote control of an industrial computer applies a display card to display operational signals in a monitor. The speed of operational signals displaying is highly related to the bus specification of a display card. Please refer to FIG. 1 . Illustrated in FIG. 1 is a schematic diagram of a conventional industrial computer including a backplane 100, and a CPU interface card 120. An ISA padded edge 104 and a peripheral component interconnect (PCI) padded edge 106 positioned on the under edge of a CPU interface card 120 electrically connect and plug vertically into an ISA expansion slot 108 and a PCI expansion slot 110 on the backplane 100 simultaneously. An accelerated graphic port (AGP) expansion slot 112 is provided on the lateral side of a CPU interface card 102 for horizontally receiving an external AGP display card 114 and electrically connecting a monitor or a terminal through an AGP conduit. Signals are transmitted between the CPU interface card 102 and the backplane 100 by buses of the ISA padded edge 104 and the PCI edge connect 106. However, due to that the AGP display card 114 is horizontally positioned, once being plugged into the AGP expansion slot 112, the AGP display card 114 may occupy adjacent space of other expansion slots so as to reduce the number of applicable interface cards that can be used.

Though components on an AGP display card can be built on-board on the CPU interface card 102 to reduce the occupied space, when a user according to his demands plugs a different display card into the slot, the on-board display card will be rendered useless, which is an unnecessary cost. Meanwhile, being built on the CPU interface card 102, associated circuits layouts and external conduits receivers of the AGP expansion slot 112 will occupy so much space so as to make volume of the CPU interface card large. How to arrange the AGP components to reduce volume of the CPU interface card and increase application flexibility is a focus of the backplane design.

Besides, due to the ISA padded edge 104, the PCI padded edge 106 and their related circuits and components of the CPU interface card occupying some parts of the circuit board, the space of the whole CPU interface card 102 is too large that a backplane of an industrial computer has to apply a longer expansion slot, which influences the size of the backplane and the arrangement flexibility. How to increase the arrangement flexibility of circuits of expansion slots and CPU interface cards on a backplane is also a focus of the industrial computer industry.

### SUMMARY OF INVENTION

It is therefore a primary objective of the claimed invention to provide an improved backplane having at least a first type bus expansion slot, a second type bus expansion slot, a bus bridge device, and an AGP slot mounted thereon for receiving a CPU interface card, a PCI bus, an AGP bus, and an ISA/EISA bus being positioned parallel to increase selection flexibility of an AGP card, which reduces the CPU interface card volume due to no demands for applying an AGP expansion slot or AGP interface. The AGP display card and CPU interface card are plugged vertically into the AGP expansion slot and the standard bus expansion slot on the backplane so as to overcome the problem of an AGP display card occupying too much space for plugging horizontally to the CPU interface card.

Another objective of the claimed invention is to provide a backplane having an AGP wherein an applied standard bus expansion slot, such as a PCI bus, an AGP bus, and an ISA/EISA bus can communicate with an adjacent AGP expansion slot, which enables an operator to choose a better AGP display card to facilitate communications.

Another objective of the claimed invention is to provide a backplane having an AGP wherein a bus bridge device and a first type bus expansion slot such as a PCI bus expansion slot for receiving a CPU interface card, are positioned parallel thereon such that a first type bus signal generated by the CPU interface card such as a PCI bus signal, is converted to a necessary second type bus signal, such as an ISA/EISA signal thereby allowing communication in different-type bus signals between the backplane and the CPU interface card.

Another objective of the claimed invention is to provide a backplane having an AGP wherein a bus bridge device and a first type bus expansion slot such as a PCI bus expansion slot, for receiving a CPU interface card are positioned parallel thereon to control all the second type bus signals on the backplane such that the CPU interface need no converting chipsets which reduces the CPU interface card volume and increases the CPU interface card flexibility.

According to the above-mentioned objectives, the claimed invention provides a backplane having an AGP. In the first embodiment, the backplane of the claimed invention joins with a CPU interface card to constitute a computer system. The backplane comprises a plurality of first type bus expansion slots, an AGP expansion slot, a plurality of second type bus expansion slots, and a bus bridge device.

Each first type bus expansion slot such as a PCI bus slot, electrically receives the CPU interface card therein such that the first type bus signals such as PCI bus signals, are transmitted between the backplane and the CPU interface card.

The AGP expansion slot are positioned on the backplane, in parallel with the first type bus expansion slot for receiving the CPU card, to further receive an external AGP display card whereby there are no demands for other AGP expansion slots set on the CPU interface card. The volume of the CPU interface card therefore can be reduced. For the conventional backplane, the problem that an AGP display card for inserting horizontally on the CPU card may occupy space of other adjacent expansion slots is overcome, too.

The bus bridge device electrically is connected to the first expansion slot whereby the first type bus signals such as PCI signals in the first type expansion slot, can be converted to be another second type bus signals such as ISA/EISA signals whereby the second type expansion slot can communicate with the CPU interface card via the bus bridge device in different bus signals while accommodating an external interface card therein.

The bus bridge device positioned on the backplane can control all interface cards of the second expansion slots. Therefore, no converting chipsets are required on the CPU interface card so as to reduce the volume of the CPU interface card and increase the available circuits layout area of the CPU interface card.

Besides, in the preferred embodiment of the claimed invention, the bridge device can be an adaptive connector module or one having a converting chipset welded on the backplane. If a bridge device having chipsets welded on the backplane is selected, pins of the chipsets must be close to the first type bus expansion slot to avoid interference to its circuits and to receive the first type bus signals from the CPU interface card.

A bridge device according to the claimed invention comprises an adaptor, and a pair of mated connectors wherein one of mated connectorsis positioned on the backplane and provided with a plurality of receiving holes to electrically connecting with the first type bus expansion slot. The adaptor has the other mating connector mounted thereon and disposed with a plurality of pins electrically corresponding to the holes of said connectors, and a chipset for converting a first type bus signal to another type bus signal. According to the second preferred embodiment of the claimed invention, the backplane is disclosed to comprise a plurality of first type bus expansion slots, an AGP expansion slot, a plurality of second type bus expansion slots, and a bus bridge device wherein the first type bus expansion slot applies PCI bus and the second type bus expansion slot applies ISA/EISA bus. At least one of the second type bus expansion slots is arranged collinearly with the first type bus expansion slot on the backplane. Functions and designs of the otherelements according to the second preferred embodiment, i.e. AGP expansion slots, second type bus expansion slots, and bus bridge device are the same as described in the first preferred embodiment.

According to the third preferred embodiment of the claimed invention, a backplane is disclosed to comprise a plurality of first type bus expansion slots and an AGP expansion slot wherein the first type bus expansion slot applies an ISA/EISA bus, but functions and designs of the AGP expansion slot is the same as described in the first preferred embodiment of the claimed invention. Additionally, due to that the backplane and the CPU interface card in the third preferred embodiment are directly electrically connected with each other through an ISA/EISA bus, there is no demand to apply a second type bus expansion slot and a bus bridge device.

According to the fourth preferred embodiment of the claimed invention, a backplane is disclosed to comprise a plurality of first type bus expansion slots, a first AGP expansion slot, a plurality of second type bus expansion slots, a plurality of third type bus expansion slots, and a bus bridge device. The first type bus expansion slot applies a PCI bus, the second type bus expansion slot applies an ISA/EISA bus, and the third type bus expansion slot applies an AGP bus, functioned as a second AGP expansion slot. The third type bus expansion slot and the first type bus expansion slot are arranged collinearly on the backplane such that the CPU interface card can be inserted into both them, simultaneously. The AGP expansion slot positioned on the backplane is designed as an electrical expansion of the third type bus expansion slot and is applied to receive an external AGP interface card therein. Functions and designs of the other elements according to the fourth preferred embodiment of the claimed invention, i.e., AGP expansion slot, the second type bus expansion slot, and the bus bridge device are the same as described in the first preferred embodiment of the claimed invention.

As aforementioned, the claimed invention discloses a backplane having with an AGP to make an efficient use for the area of the backplane, reduce the dimension of the CPU interface card, and facilitate communications between the backplane and the CPU interface card by way of design of installing an AGP expansion slots and a bus bridge device on the backplane.

These and other objectives of the claimed invention will no doubt become obvious to those of ordinary skill in the art after reading the following detailed description of the preferred embodiments, which are illustrated in the various figures and drawings.

### BRIEF DESCRIPTION OF DRAWINGS

FIG. 1 is a schematic diagram of basic structure of a prior art conventional industrial computer.

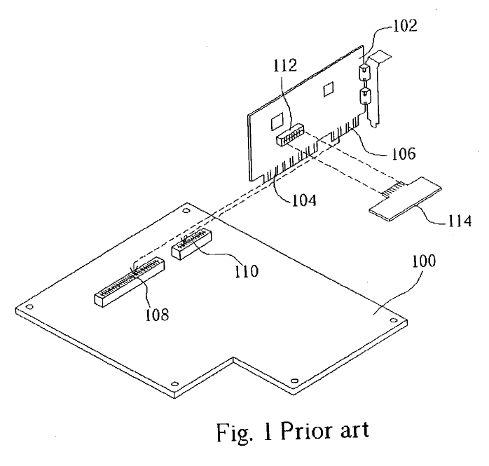

FIG. 2 is a schematic diagram of the first preferred embodiment of the present invention showing a backplane having an AGP.

FIG. 3 is a schematic diagram of the second preferred embodiment of the present invention showing a backplane having an AGP.

FIG. 4 is a schematic diagram of the third preferred embodiment of the present invention showing a backplane having an AGP.

FIG. 5 is a schematic diagram of an adaptive bus bridge device according to the present invention.

FIG. 6 is a schematic diagram of the fourth preferred embodiment of the present invention showing a backplane having an AGP.

### DETAILED DESCRIPTION

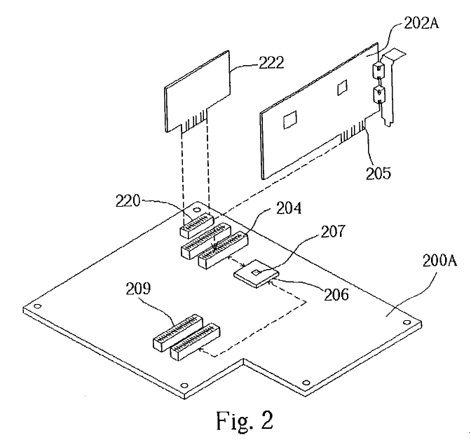

Please refer to FIG. 2. Illustrated in FIG. 2 is a schematic diagram of the first preferred embodiment of a backplane 200A according to the present invention. The backplane 200A electrically cooperates with an external CPU interface card 202A to constitute a computer system. The backplane 200A comprises a plurality of first type bus expansion slots 204 such as a PCI expansion slot, and an AGP expansion slot 220, a plurality of second type bus expansion slots 209 such as ISA/EISA expansion slots, and a bus bridge device 206.

Beside the CPU interface card 202A, each first type bus expansion slot 204 can selectively receives a variety of other interface cards therein such as a video processing interface card, a sound card, or an Ethernet network card to expand functions of the industrial computer. A first type bus padded edge 205 is formed with the CPU interface card 202A and is used to be inserted into a corresponding first type bus expansion slot 204 to perform functionality of the CPU interface card 202A through communication between the first type bus expansion slot 204 and the CPU interface card 202A.

The AGP expansion slot 220 is welded on the backplane 200A, parallel with the first type bus expansion slot 204, for receiving electrically an external AGP display card 222 therein wherein a chip of the AGP display card 222 facilitates video signal processing needed for the CPU interface card 202A and transmits the processed video signals to an displayer instrument. The design the AGP expansion slot 220 being positioned parallel with the first type bus expansion slot 204, can increase flexibility of selecting other AGP display cards and reduces the using volume of the CPU interface card 202A without demands of installation of other AGP expansion slots and AGP interface chips thereon. Because the AGP display card 222 and the CPU interface card 202A are inserted vertically into both the AGP expansion slot 220 and the first type bus expansion slot 204, the problem of an AGP display card, which occupies space of other adjacent expansion slots on the backplane, can be overcome.

The first type bus of the CPU interface card 202A, such as a PCI bus, is capable of communicating with the AGP bus on the backplane 200A for enabling a user to choose a better AGP display card to increase transmission speed of video signals.

In addition, the bridge device 206 is positioned adjacent to the first type bus expansion slot 204 for electrically connecting the first type bus expansion slot 204 and converting a first type bus signal such as a PCI signal into a second type bus signal. The second type bus signal is used in the second type bus expansion slot 209 for receiving an external interface card therein. Meanwhile, the second type bus can be an ISA/EISA bus.

The bus bridge device 206 of the backplane 200A can not only convert the first type bus signal from the CPU interface card 202A, such as a PCI bus signal, to a second type bus signal such as an ISA/EISA bus signal, but can also control all interface cards of the ISA/EISA expansion slot 209 so as to replace a prior art arrangement that it is necessary to provide much space on the CPU interface card for positioning a bus signal converting chip such as a PCI-to-ISA chip. Therefore, the present invention can increase utilities of the area for circuit layout on a CPU interface card or reduce the dimension of the CPU interface card 202A. In other words, on a CPU interface card 202A having the same area, the present invention can replace bus signal converting chips with other circuits, or can efficiently modify the original layouts of the CPU interface card 202A to reduce the area of the CPU interface card 202A and the occupied space.

Each first type expansion slot 204 on the backplane 200A, such as a PCI expansion slot, is applied for receiving an interface card to perform functionality of the interface card by transmitting a first type bus signals wherein the interface card can be a sound card, an Ethernet card, or other type interface cards than the mentioned CPU interface card 202A.

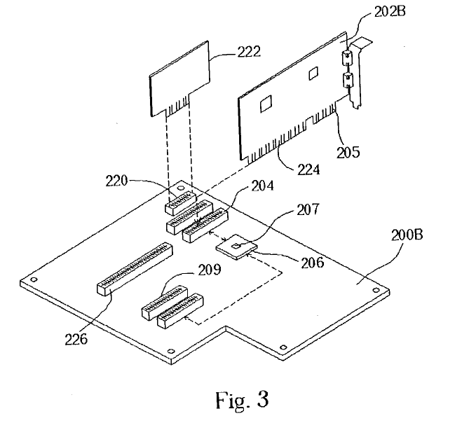

Please refer to FIG. 3. Illustrated in FIG. 3 is a second preferred embodiment of backplane according to the present invention. Compared to the first preferred embodiment illustrated in FIG. 2, in addition to the same second type bus expansion slot 209 such as a first ISA/EISA bus expansion slot, the backplane 200B in FIG. 3 further has another second type bus expansion slot 226 such as a second ISA/EISA expansion slot, positioned parallel to the first type bus expansion slot 204. By contrast, an external CPU interface card 202B is a prolonged interface card and forms thereon a first type bus padded edge 205 as a PCI type and a second type bus padded edge 224 as an ISA/EISA type for inserting the CPU interface card 202B into both the first type bus expansion slot 204 and the second type bus expansion slot 226, simultaneously. Designs and functions of both the AGP expansion slot 220 and the bus bridge device 206 are the same as disclosed in FIG. 2.

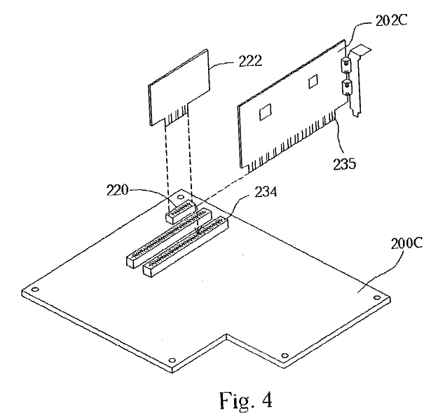

Please refer to FIG. 4. Illustrated in FIG. 4 is a third preferred embodiment according to the present invention. Compared to the first preferred embodiment illustrated in FIG. 2, the third preferred embodiment uses only one AGP expansion slot 220 directly welded on the backplane 200C, adjacent to the first type bus expansion slot 234 but no second type bus expansion slot and bus bridge device. In the third preferred embodiment, the first type bus expansion slot 234 and a padded edge 235 formed on the CPU interface card 202C both conform to the ISA/EISA bus standard specification. It means that the CPU interface card 202C can be applied with an ISA/EISA bus since there is no demand of a bus bridge device for converting a PCI bus signal to an ISA/EISA bus signal.

Besides, in the above preferred embodiments of the present invention, the bus bridge device 206 can be designed as an adaptive connector module, or one having a converting chip welded on the backplane 200C wherein pins of the converting chip should be positioned near the first type bus expansion slot 204 to avoid signals interference and receive the first type bus signal such as a PCI bus signal from the CPU interface card 202A, 202B.

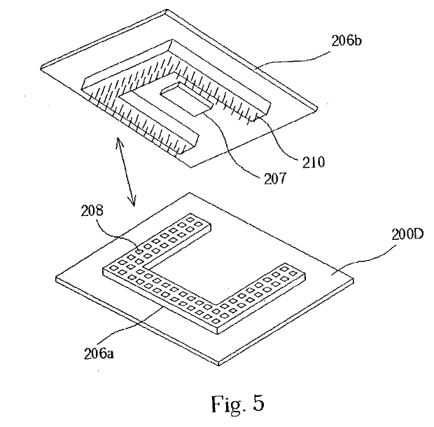

Please refer to FIG. 5. Illustrated in FIG. 5 is a schematic diagram of the present invention an adaptive bus bridge device 206. The bus bridge device 206 comprises a pair of mated connectors 206a and 210, a chipset 207, and a plate-like adaptor 206b wherein the connector 206a is positioned on the backplane 200D and provided with a plurality of receiving holes 208 for electrically connecting to the first type bus expansion slot 204. The adaptor 206b is disposed with the other mating connector 210 having a plurality of pins for electrically connecting the receiving holes 208 of said connector 206a. The chipset 207 can be as a PCI-to-ISA chipset, applied to convert a first type bus signal such as a PCI signal to a second type bus signal such as an ISA signal. The connector 206a of the bus bridge device 206,with an “inverted U” shape, is positioned on the backplane and its corresponding mating connector 210 with the same “inverted U” shape is also positioned on the adaptor 206b. By means of a 3-row structure defined with the “inverted U” shape, while pins of the mating connector 210 of the adaptor 206b are inserted into the respective receiving holes 208 of the connector 206a, both connectors 206a and 210 can be closely mated in a great electrical connection and the chipset 207 located inside can be protected well.

Please note that there are other selectable types for the adaptor 206b and the connector 206a. For example, the adaptor 206b can be a designed as an interfacecard type with chipset for inserting into another expansion slot functioned as the connector 206a for converting a PCI bus to an ISA/EISA bus. When the bus bridge device 206 according to the present invention is positioned on the backplane 200D, it will not occupy the expansion slot space and have no signal interruption from other interface cards of other expansion slots.

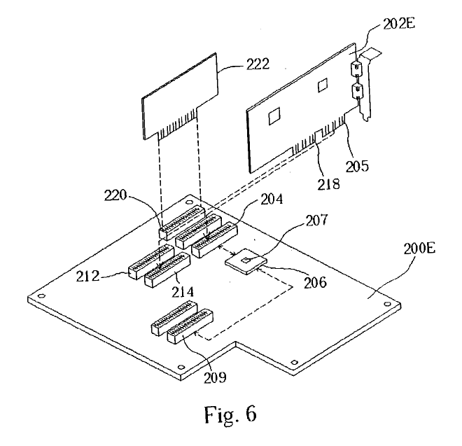

Please refer to FIG. 6. Illustrated in FIG. 6 is a fourth preferred embodiment of the present invention. Compared to the first preferred embodiment illustrated in FIG. 2, in addition to existence of the same AGP expansion slot 220 adjacent with the first type bus expansion slot 204, the backplane 200E illustrated in FIG. 6 further has a third type bus expansion slot 212 such as a second AGP expansion slot positioned collinearly with the first type bus expansion slot 204. An external CPU interface card 202E is a prolonged CPU interface card with a first type bus padded edge 205 such as a PCI type and a third type bus padded edge 218 such as an AGP type for inserting into both the first type bus expansion slot 204 and the third type bus expansion slot 212, simultaneously.

Being the same as the second preferred embodiment illustrated in FIG. 2, the bus bridge device 206 connects electrically the first type bus expansion slot 204 for converting the first type bus signal to a standard interface bus signal such that the interface expansion slot of the backplane 200E has the standard interface bus specification for communication between the CPU interface card 202E and the second type bus expansion slot 212 by using the bus bridge device 206.

The third type bus expansion slot 212 is positioned on the backplane 200E for electrically connecting the CPU interface card 202E wherein the third type bus expansion slot 212 is positioned collinearly with the first type bus expansion slot 204 such as a PCI expansion slot such that the first type bus padded edge 205, such as a PCI type, and the third type bus padded edge 218, such as an AGP type, of the CPU interface card 202E can be inserted into both the first type bus expansion slot 204 such as a PCI expansion slot and the third type bus expansion slot 212 such as a second AGP expansion slot, simultaneously wherein the third type bus expansion slot 214 is designed as an electrical expansion of the third type bus expansion slot 212 for receiving an external AGP interface card 222 therein.

An AGP according to the present invention is designed as a specific bus for a display card between a graphic chipset and a microprocessor. The AGP specification can transmit a mass of video signals between memory and a video chip in a three-dimensional illustrating or animation software environment. The AGP specification of the backplane 200E in the present invention can be 1×/2×/4× or even a higher level.

In conclusion, the present invention provides a backplane with an AGP which utilities a bus bridge device and an AGP expansion slot disposed adjacent to a PCI expansion slot for receiving a CPU interface card therein. Therefore, the dimensional design of CPU interface card can be reduced, the space on the backplane is efficiently used, and the transmission speed can be increased between the backplane and the CPU interface card. The application flexibility of the backplane is increased.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A backplane applied joined with a CPU interface card to constitute a computer system, the backplane comprising:
a first type bus expansion slot providing a first type bus signal and electrically receiving the CPU interface card to facilitate communications between the CPU interface card and the backplane;
a second type bus providing a second type bus signal; and
a bus bridge device positioned on the backplane, electrically connected with the first type bus expansion slot to convert the first type bus signal into the second type bus signal thereby allowing communication in different-type bus signals between the CPU interface card and the second type bus.

2. The backplane as described in claim 1 wherein the first type bus expansion slot is a peripheral component interconnect (PCI) expansion bus.

3. The backplane as described in claim 1 wherein the bus bridge device of the backplane comprises:
a connector positioned on the backplane, the connector having a plurality of receiving holes and electrically connected with the first type bus expansion slot; and
an adaptor provided with a mating connector having a plurality of pins corresponding to the holes of said connector, and a chipset used to convert the first type bus signal to the second type bus signal.

4. The backplane as described in claim 1 wherein the bus bridge device of the backplane comprises a chipset connected electrically to the backplane and used to convert the first type bus signal to the second type bus signal.

5. The backplane as described in claim 1 further comprising a third type bus expansion slot which is positioned on the backplane, collinearly adjacent to the first expansion slot, and is applied to be electrically connected to the CPU interface card for inserting the CPU interface card into the first type and third type bus expansion slots, simultaneously.

6. The backplane as described in claim 5 wherein the third type bus expansion slot is an accelerated graphic port (AGP) expansion slot.

7. The backplane as described in claim 1 further comprising an accelerated graphic port (AGP) expansion slot positioned parallel to the first type bus expansion slot on the backplane and electrically connected to the CPU interface card, and applied to accommodate an external accelerated graphic port (AGP) display card therein.

8. The backplane as described in claim 1 wherein the second type bus electrically is connected to a second type bus expansion slot used for receiving an associated interface card therein.

9. The backplane as described in claim 1 wherein the second type bus is an ISA/EISA bus.

10. The backplane as described in claim 1 further comprising a second type bus expansion slot positioned collinearly adjacent to the first type bus expansion slot on the backplane and electrically connected to the CPU interface card thereby facilitating insertion of the CPU interface card into both, the first and second types bus expansion slots, simultaneously.

11. A backplane joined with a CPU interface card to form a computer system, the backplane comprising:
a PCI expansion slot electrically connected to the CPU interface card, provided with a PCI bus, and according to the PCI bus specification, performing communication in a PCI bus signal between the backplane and the CPU interface card;
an ISA/EISA expansion slot positioned on the backplane and receiving an ISA/EISA interface card therein for transmitting an ISA/EISA signal; and
a bus bridge device interconnecting between the PCI expansion slot and the ISA/EISA expansion slot for converting the PCI bus signal to the ISA/EISA signal to enable the CPU interface card to communicate with the ISA/EISA interface card in different-type bus signals.

12. The backplane as described in claim 11 wherein the bus bridge device comprises:
a pair of mated connectors, one of which is positioned on the backplane and is provided with a plurality of receiving holes, for electrically connecting with the PCI expansion slot; and
an adaptor that the other mating connector is mounted on having a plurality of pins electrically corresponding to the holes of said connector, and a chipset for converting the PCI bus signal to an ISA/EISA bus signal.

13. The backplane as described in claim 11 further comprising:
a first AGP expansion slot positioned on the backplane for electrically connecting to the CPU interface card wherein the first AGP expansion slot is positioned collinearly adjacent to the PCI expansion slot for inserting the CPU interface card into both the PCI expansion slot and the first AGP expansion slot, simultaneously; and
a second AGP expansion slot positioned on the backplane and functioning as electrical expansion of the first AGP expansion slot, and used for receiving an external AGP interface card therein.

14. A bus bridge device positioned on a backplane wherein the backplane joins with a CPU interface card to constitute a computer system, the bus bridge device comprising:
a socket positioned on the backplane and provided with a plurality of receiving holes and electrically connected with at least one first type bus expansion slot;
an adaptor having a plurality of pins corresponding electrically to the receiving holes of the socket; and
a chipset interconnecting between the above-mentioned socket and the adaptor thereby converting a first type bus signal to a second type bus signal.

15. The bus bridge device of the backplane as described in claim 14 wherein the first type bus expansion slot is a PCI expansion slot.

16. The bus bridge device of the backplane as described in claim 14 wherein the device is electrically connected to the second type bus expansion slot positioned on the backplane.

17. The bus bridge device of the backplane as described in claim 16 wherein the second type bus expansion slot is an ISA/EISA slot.

18. The bus bridge device of the backplane as described in claim 14 wherein the adaptor further comprises a mating connector having a plurality of pins.

19. The bus bridge device of backplane as described in claim 14 wherein the adaptor has a “ [symbol] ” shape for holding the chipset inside the adaptor.

20. A backplane joined with a CPU interface card for constituting a computer system, the backplane comprising:
a first type bus expansion slot positioned on the backplane and electrically receiving the CPU interface card thereinfor performing functionality of the CPU interface card in a first type bus signal; and
an AGP expansion slot positioned on the backplane, adjacent to the first bus expansion for holding an external AGP display card whereby the AGP display card and the CPU interface card are respectively inserted into the AGP expansion slot and the first type bus expansion slot vertically.

21. The backplane as described in claim 20 further comprising a second type bus expansion slot positioned on the backplane, collinearly with the first type bus expansion slot, for inserting the CPU interface card into both the first and second types bus expansion slots, simultaneously.

22. The backplane as described in claim 21 wherein the first type bus expansion slot is a PCI expansion slot.

23. The backplane as described in claim 22 wherein the second type bus expansion slot is an ISA/EISA expansion slot.

24. The backplane as described in claim 22 wherein the second type bus expansion slot is an AGP expansion slot.

25. The backplane as described in claim 21 wherein the first type bus expansion slot is an ISA/EISA expansion slot.

26. A backplane having an AGP expansion slot for electrically connecting to a CPU interface card, the backplane comprising:
a PCI expansion slot for receiving the CPU interface card therein for performing functionality of the CPU interface card in PCI bus signal; and
an first AGP expansion slot positioned adjacent to the PCI expansion slot and electrically connected to the CPU interface card for connecting an external AGP display card to the CPU interface card.

27. The backplane as described in claim 26 further comprising a second AGP expansion slot positioned collinearly with the PCI expansion slot for inserting the CPU interface card into both the PCI expansion slot and the second AGP expansion slot, simultaneously.

28. The backplane as described in claim 26 further comprising an ISA/EISA expansion slot positioned collinearly with the PCI expansion slot for inserting the CPU interface card into both the PCI expansion slot and the ISA/EISA expansion slot, simultaneously.

29. A backplane having an AGP expansion slot, connected electrically to a CPU interface card, comprising:
an ISA/EISA expansion slot for receiving the CPU interface card therein for performing functionality of the CPU interface card in ISA/EISA bus signal; and
an AGP expansion slot positioned adjacent to the ISA/EISA expansion slot and electrically connected to the CPU interface card for connecting an external AGP display card to the CPU interface card.
